(19) United States
(12) Patent Application Publication
(10) Pub. No.: US 2012/0028039 A1
(43) Pub. Date: Feb. 2, 2012

(54) IMPRESSION COMPOSITION

(75) Inventor: Martin Klenke, Blieskastel (DE)

(73) Assignee: NANOGATE INDUSTRIAL SOLUTIONS GMBH, Quierschied-Goettelborn (DE)

(21) Appl. No.: 13/262,964

(22) PCT Filed: Mar. 9, 2010
(86) PCT No.: PCT/EP2010/052939

§ 371 Date: Oct. 5, 2011

Related U.S. Application Data
(60) Provisional application No. 61/167,343, filed on Apr. 7, 2009.

(30) Foreign Application Priority Data
Apr. 7, 2009 (DE) 09157498.8

(51) Int. Cl. B32B 27/36; C09K 11/08; B29C 35/08; C09K 11/02

(52) U.S. Cl. 428/339; 252/301.36; 264/496

(57) ABSTRACT

The invention relates to a molded part and to a process for producing such molded part with a surface structure.

In particular, the invention relates to a transparent molded part comprising a sheet-like substrate and, provided on a major surface of said substrate, a layer having a layer thickness within a range of from 3 to 300 μm and consisting of a solvent-free polymerized composition containing:
a) from 35 to 75% by weight of at least one partially fluorinated acrylate;
b) from 24.9 to 60% by weight of at least one non-fluorinated acrylate; and
c) from 0.1 to 5% by weight of at least one photoinitiator;
   wherein said layer has a surface structure with diffractive surface elements having a maximum structural size of defects of such surface elements of up to 100 nm on the surface facing away from the substrate, characterized in that said composition contains luminescent pigments.

The invention relates to a molded part and to a process for producing such molded part with a surface structure.

U.S. Pat. No. 4,511,209 A describes compositions with improved optical properties based on highly fluorinated monofunctional acrylates that are cross-linked for use in optical objects. The preferred components of the compositions are (1) a highly fluorinated monofunctional acrylate, (2) a trifunctional or higher functional acrylate serving as a cross-linking agent, (3) a mono- or polyfunctional thiol synergist, and (4) a photoinitiator, such as a UV initiator.

WO 92/21492 describes glass objects with an improved moisture resistance that is to be achieved by coating the surface. The reactive coating composition comprises from about 10 to 74% by weight of a film-forming monomer with two (meth)acryloyl groups per molecule, from about 5 to 50% by weight of a reactive cross-linking monomer with at least three (meth)acryloyl groups per molecule, from about 20 to 60% by weight of a fluorinated (meth)acrylate monomer, from about 1 to 30% by weight of an organosilane monomer with one or more functional groups suitable for reaction with said glass substrate that includes a non-hydrolyzable organic functional group which is able to react with said (meth)acryloyl groups, and an effective amount of a polymerization initiator.

EP 0 536 743 A1 describes a resin composition containing a UV-cross-linking resin and a reactive component that contains at least one silicon atom with an alkoxy group or a halogen atom, that further contains at least two functional group able to undergo a chemical bond with said UV-cross-linking resin.

EP 0 333 464 A1 describes an optical fiber with a coated core, wherein said coating has a lower refractive index than that of the core. The coating comprises a fluorinated monoacrylate, a multifunctional cross-linking acrylate and a photoinitiator, wherein the composition contains less than 0.3% by weight of a mono- or polyfunctional thiol.

EP 0 196 212 A2 describes an adhesive composition for optical fibers. In particular, the adhesive composition comprises a defined fluoroacrylate and further optionally multifunctional acrylates or methacrylates present for adjusting the refractive index. Further, the adhesive composition optionally contains a photoinitiator.

EP 0 478 261 A2 describes a process for the preparation of an oxygen-permeable polymer, comprising the polymerization of at least one defined alkene, one defined siloxane that has an acrylate group and another fluorinated acrylate.

Known illumination means for displays, for example, of mobile applications, have a light source which is a tubular light source (CCFL; cold cathode fluorescent lamp), for example. The light emitted by the light source is coupled into a molded part with a wedge-shaped cross-section or cuboid shape on a front surface thereof. Especially due to the wedge-shaped embodiment of the molded part, a total reflection of the light beams at the phase boundary and, through corresponding scattering centers, an exiting of the light beams at the surface of the wedge-shaped molded part occur. The surface of the wedge-shaped molded part is arranged opposite to the display to be transilluminated. The surface of the molded part has such a structure that the light exits from the optical waveguide by refraction. The thus refracted light is collimated by several films provided between the molded part and the display and guided in such a way that an essentially white light arrives at the display. The structure of such illumination means is complicated, all the more so since several films must be inserted in one frame or the like, for example, and it must be ensured that shifting or the like of the films is avoided. Due to the complicated structure, the manufacturing cost is high. Further, there is a risk of functional defects.

EP 1 700 871 B1 describes a transparent molded part comprising a sheet-like substrate and, provided on a major surface of said substrate, a layer having a layer thickness within a range of from 3 to 300 μm and consisting of a solvent-free polymerized composition containing:
a) from 35 to 75% by weight of at least one partially fluorinated acrylate;
b) from 24.9 to 60% by weight of at least one non-fluorinated acrylate; and
c) from 0.1 to 5% by weight of at least one photoinitiator;
   wherein said layer has a surface structure with diffractive surface elements having a maximum structural size of defects of such surface elements of up to 100 nm on the surface facing away from the substrate.

It is the object of the invention to provide a process for producing a luminous surface structure of a molded part that enables the reliable and inexpensive preparation without additionally necessary films.

In a first embodiment, the object of the invention is achieved by a transparent molded part comprising a sheet-like substrate and, provided on a major surface of said substrate, a layer having a layer thickness within a range of from 3 to 300 μm and consisting of a solvent-free polymerized composition containing:
a) from 35 to 75% by weight of at least one partially fluorinated acrylate;
b) from 24.9 to 60% by weight of at least one non-fluorinated acrylate; and
c) from 0.1 to 5% by weight of at least one photoinitiator;
   wherein said layer has a surface structure with diffractive surface elements having a maximum structural size of defects of such surface elements of up to 100 nm on the surface facing away from the substrate, characterized in that said composition contains luminescent pigments.

According to the invention, when a surface structure of a molded part is produced, the impression composition is applied to a negative casting mold and/or a molded part. Preferably, the negative casting mold has, as a negative form, the surface structure to be transferred to the molded part as a substrate. The transfer of the surface structure is effected by means of the curable impression composition which becomes bonded to the surface of the molded part after curing. The molded part is a substrate preferably prepared from a transparent material, especially transparent plastic material. The transparent plastic materials preferably comprise those selected from the group of methacrylate polymers (for example, PMMA), polycarbonates, cyclic olefin polymers, styrene polymers, polyacrylates, polyethersulfones and/or polyimides. The molded part may also consist of glass.

The impression composition according to the present invention contains:
a) from 35 to 75% by weight of at least one partially fluorinated acrylate;
b) from 24.9 to 60% by weight of at least one non-fluorinated acrylate; and
c) from 0.1 to 5% by weight of at least one photoinitiator;
   and is characterized by containing luminescent pigments.

Partially fluorinated acrylates within the meaning of the present invention are preferably linear, branched and/or cyclic alkyl acrylates or mixtures of such acrylates in which, in particular, the one or two carbon atoms adjacent to the acrylate function are not fluorinated, and in which the alkyl chains preferably have from 6 to 12 carbon atoms. Advantageously, the remaining carbon atoms of the alkyl radical are perfluorinated. In particular, the partially fluorinated acrylate is a perfluoroalkylethyl acrylate (for example, Fluowet® AC 600 from Clariant), wherein the ethyl group is not fluorinated and, in particular, the perfluorinated alkyl radical has from 4 to 10 carbon atoms. If the alkyl chains are longer, the demoldability may no longer be ensured, or two phases of the partially fluorinated and non-fluorinated acrylate monomers may form. If two or more phases are formed in the composition of the monomers, this may lead to more light scattering (haze) in the cured layer. However, if the alkyl chains are shorter, the resulting impression composition may be too low-viscous.

Therefore, the molecular weight of the partially fluorinated acrylate monomers is preferably within a range of from 350 to 500 g/mol. If the molecular weight of the partially fluorinated acrylate monomers is above this range, the resulting impression composition may easily obtain too high a viscosity, which may result in an increased formation of defects and artifacts of the surface elements. If the molecular weight of the partially fluorinated acrylate monomers is below this range, the resulting impression composition may easily obtain too low a viscosity, which may result in too low a layer thickness of the layer as a portion of the molded part according to the invention.

Advantageously, the melting point of the partially fluorinated acrylate monomers is within a range of from 15 to 40° C. Since the impression composition is preferably employed at room temperature, the viscosity of the impression composition can be additionally controlled by selecting the melting point of the partially fluorinated acrylate monomers within the preferred range near room temperature.

Non-fluorinated acrylates according to the invention are preferably linear, branched and/or cyclic alkyl acrylates or mixtures of such acrylates. Particularly preferred are monomers having two or more acrylate functions and/or two or more alcohol groups and/or at least one ether bridge (for example, dipropylene glycol diacrylate, diethylene glycol diacrylate, 1,6-hexanediol diacrylate, tetraethylene glycol diacrylate, triethylene glycol diacrylate, tripropylene glycol diacrylate, alkoxylated hexanediol diacrylate, or esterdiol diacrylate or mixtures of such monomers), because these monomers, due to their multiple functionality, result in particularly stable and optically flawless layers as a portion of the molded part according to the invention. Advantageously, the alkyl chains have from 6 to 12 carbon atoms. If the alkyl chains are longer, two phases of the partially fluorinated and non-fluorinated acrylate monomers are easily formed. However, if the alkyl chains are shorter, the resulting impression composition may be too low-viscous.

The molecular weight of the non-fluorinated acrylate monomers according to the invention is preferably within a range of from 150 to 340 g/mol. If the molecular weight of the partially fluorinated acrylate monomers is above this range, the resulting impression composition may easily obtain too high a viscosity, which may result in an increased formation of defects and artifacts of the surface elements. If the molecular weight of the partially fluorinated acrylate monomers is below this range, the resulting impression composition may easily obtain too low a viscosity, which may result in too low a layer thickness of the layer as a portion of the molded part according to the invention.

Photoinitiators within the meaning of the invention are preferably phenylketone derivatives (for example, Irgacure® 184 and/or Irgacure® 819 from Ciba Spezialitätenchemie Lampersheim GmbH), because these have a particularly low negative impact on the optical properties of the resulting molded part according to the invention.

Preferably, the impression composition contains from 50 to 65% by weight, especially from 55 to 60% by weight, of a partially fluorinated acrylate or a mixture of different partially fluorinated acrylates, because when the content of the partially fluorinated acrylate is too high or too low, phase separations of the partially fluorinated and non-fluorinated acrylate monomers may easily form.

The impression composition advantageously contains from 34.9 to 45% by weight of a non-fluorinated acrylate or a mixture of different non-fluorinated acrylates. For a lower content of non-fluorinated acrylates, an increased formation of two-phase impression composition systems was observed. The formation of phase separations in the composition of the monomers results in more light scattering (haze) in the cured layer. When the proportion of non-fluorinated acrylates is higher, an enhanced adhesion of the cured impression composition to the negative casting mold and thus problems during the demolding occurred.

Advantageously, the impression composition contains from 1 to 2% by weight of a photoinitiator or mixture of different photoinitiators. This causes a particularly high cross-linking of the monomers and thus an improved optical quality and mechanical loadability.

Preferably, the impression composition has a viscosity of from 2 to 30 mPa·s (cP) at room temperature. The surface structure of the negative casting mold or the molded part can be reproduced particularly exactly thereby. The viscosity can be measured at 25° C. with a Brookfield viscometer at a revolutions per minute of 900 and a CAP-1 spindle and a sample volume of 67 μl.

Preferably, the impression composition is one-phase and/or homogeneous and advantageously has a density within a range of from 1 to 1.5 g/ml. Thus, the impression composition has a higher density than that of usual organic compositions and liquids and can displace any organic liquids present from the negative casting mold. Thus, defects of the cured layer with the surface elements can be avoided in turn.

Preferably, the impression composition is free from solvents, because this not only results in a more environment-friendly preparation process, but in addition, the solvent which may escape upon curing can lead to defects in the surface structure of the molded part according to the invention.

In particular, the object of the invention is achieved by a transparent molded part comprising a sheet-like substrate and, on a major surface of the substrate, a layer having a layer thickness within a range of from 3 to 300 μm and consisting of a polymerized impression composition according to the invention, wherein the layer has a surface structure with diffractive surface elements having a maximum structure size of defects of such surface elements of up to 50 nm on the surface facing away from the substrate.

Defects within the meaning of the invention are all those structures on the surface of the layer of the molded part according to the invention that are unintentional. These include, for example, disruptions, molding defects and similar defects. For example, if the diffractive surface elements of the molded part according to the invention have a size of from 0.04 to 10,000 μm² and a mutual distance of from 1 to 100 μm, according to the invention, these surface elements preferably have no additional structures at their exterior surfaces that are unintentional and have a structure size of more than 100 nm. The maximum volume of such defects is preferably 1,000,000 nm³, especially 125,000 nm³.

Advantageously, the layer thickness of the layer according to the invention on the substrate, which together form the molded part according to the invention, is from 5 to 50 μm, especially from 10 to 30 μm. If the layer thickness is below 5 μm, the freedom of design with respect to the diffractive surface elements may be too much restricted. However, if the layer thickness is above 50 μm, there may be undesirable losses with respect to the optical quality of the molded part according to the invention.

The substrate preferably consists of glass, a methacrylate polymer (for example, PMMA), polycarbonate, a cyclic olefin polymer, styrene polymer, polyacrylate, polyethersulfone and/or polyimide, especially PMMA. These materials combine particularly good optical properties with a high compatibility with the impression composition according to the invention.

The molded part is said to be “transparent” within the meaning of the invention, if the maximum light scattering (haze) of the layer, measured according to ASTM D 1003, without taking the diffractive surface elements into account is up to 10%, preferably up to 5%, for a layer thickness of 10 mm. Thus, a particularly high light yield for the intended emission direction can be obtained, and there is less scattering loss into the unintentional emission directions.

The color of the molded part according to the invention in absence of the luminescent pigments is preferably in a color space as defined according to the CIE Lab system within a range of a<0.5 and/or b<0.5, and/or L>80%. This color space essentially corresponds to a range of 0.0<x<0.4 and 0.3<y<0.4 in the CIE 1931 color model. Due to the presence of the luminescent pigments, the desired color spaces can be created.

In a third embodiment, the object of the invention is achieved by an essentially pressureless process for the preparation of a molded part according to the invention, comprising the following steps:
a) providing a negative casting mold with shapings of surface elements;
b) introducing the impression composition according to the invention containing luminescent pigments into the negative casting mold in an amount exceeding the shapings in the surface elements;
c) applying a substrate to the exposed surface of the impression composition;
d) polymerizing the impression composition to bond the layer of the impression composition to the substrate for preparing the molded part; and
e) removing the finished molded part from the negative casting mold.

In this process, the substrate does not contact the surface of the negative mold, but practically floats on an exposed surface of the impression composition.

After the sandwich-like superposition of the substrate and the negative casting mold with the impression composition as an intermediate layer, the impression composition is cured. This is effected, for example, with the action of temperature and/or radiation, the use of UV radiation being particularly preferred, because the impression composition can be cured particularly quickly in this way. For the impression composition, a curing time of less than 3 seconds, especially of about 1 second, is sufficient because the process duration and thus the cost for the preparation process can be reduced thereby. Subsequently, the molded part and the negative casting mold are separated. Since the negative casting mold preferably has a surface that does not bond to the impression composition, or the adhesive force between the surface of the negative casting mold and the impression composition is lower than the adhesive force between the impression composition and the molded part, it is preferably possible to work without a solvent for separating the molded part from the negative casting mold. This has the advantage that the very fine surface structures of the negative casting mold are not varnished over by solvents or the like to adversely affect the exactness of the deformation of the surface structure.

“Pressureless” within the meaning of the invention means that no pressure is applied to the impression composition in steps c) and d) beyond the pressure caused by the atmospheric pressure, gravity, the overlaying substrate and the slight pressing of the substrate onto the negative casting mold. This slight pressing is to be understood as a pressure that is necessary to impress a foam having an impression hardness of from 50 to 200 N according to DIN 53576-B by 3 mm.

Due to the very fine surface structure of the negative casting mold, it is of particular importance according to the invention that the layer of the impression composition between the negative casting mold and the substrate is very uniform and especially does not have any impurities, such as air inclusions and the like. In order to achieve this, the substrate or the negative casting mold is first pressed on one side thereof. This has the result that the negative casting mold and the substrate have an extending cleft at the beginning of the pressing process starting from this first side. Subsequently, the pressing area is now increased towards the second side starting from the first side. Thus, the cleft is closed, whereby any existing air bubbles are pushed out of the cleft. Due to the capillary forces occurring in the cleft, a uniform distribution of the impression composition throughout the desired surface, especially throughout the side of the substrate adjacent to the negative casting mold, is ensured.

The negative casting mold is preferably a so-called shim. This refers to a negative casting mold which is particularly suitable for fine molding processes in the field of optics. In order to be able to avoid the use of release agents, the shim preferably has a nickel surface or consists completely of nickel. This ensures a particularly easy demolding operation. The nickel platelet preferably has a very thin design and has a thickness of about 0.1 to 1 mm, for example. Thus, the platelet can be elastically deformed with a particularly low force to accomplish the deforming. For producing the very small surface structure in the nickel layer, the nickel shim is preferably molded galvanically. The surface structure is preferably introduced into the nickel shim by lithographic processes. Thus, when the negative casting mold is prepared, established processes can be recurred to. Preferably, the nickel shim is connected, especially bonded, to a stiffening body, such as a glass-fiber plate, for stiffening in order that the deformation is actually elastic upon demolding and the platelet as such is not permanently deformed with time.

Preferably, for uniformly applying or distributing the impression composition as a impression composition between the molded part and the negative casting mold, the pressing area is continuously increased. In particular, it is ensured that pressed areas are not separated any more, to avoid the production of inclusions. Preferably, the molded part forms an opening angle with the negative casting mold during the pressing process that is preferably <3° and more preferably <2°, whereby as uniform as possible a distribution of the impression composition can be achieved. The application of the impression composition onto the negative casting mold and/or the molded part is preferably effected by dripping on, because this enables at the same time a good dosage and a particularly good spreading of the impression composition on the negative casting mold. Preferably, an exact impression composition volume is applied by means of a dispensing means in order that the reproducibility of the molded part according to the invention can be achieved more readily. For a surface of 0.0016 m², preferably, a impression composition volume of 80 μl±2 μl is applied because the negative casting mold is filled with impression composition particularly exactly thereby for the dimensions described. Thus, for the above mentioned reasons, an impression composition volume of preferably 50 ml is applied per m². In order to ensure that the surface of the molded part to be provided with a structure is wetted with impression composition throughout, the supplying of the impression composition is preferably effected with an adequate excess amount.

In order to ensure a secure bonding of the impression composition with the molded part, the surface of the substrate to be contacted with the impression composition is preferably pretreated to achieve a particularly good adhesion of the layer of cured impression composition to the substrate. It is particularly preferred to effect a pretreatment with UV radiation because free-radical reaction centers may form thereby on the surface of the substrate, and the cross-linking of the impression composition may begin at the surface of the substrate already when the impression composition is applied. When PMMA is used as the substrate and the above described impression composition is employed, a pretreatment of a few seconds, especially less than 2 seconds, is sufficient. It is particularly preferred, when the curing is promoted by UV radiation, to provide a common device for pretreatment and curing. Thus, it is possible to pretreat a substrate that is still to be coated, while another substrate already provided with impression composition is subjected to the curing of the impression composition.

It is particularly preferred to provide an inert gas atmosphere, especially an atmosphere of argon, nitrogen and/or carbon dioxide, while the impression composition is applied and/or the substrate is pressed on and/or the impression composition is cured, because the curing can be surveyed better thereby as freely as possible from external influences, such as the ozone content (source of free radicals) of the ambient air. This especially avoids the premature formation by air of free radicals or other factors that may adversely affect the impression composition.

The separation of the molded part from the negative casting mold is preferably effected by elastically deforming the molded part and/or the negative casting mold, because the negative casting mold can be reused in this way. Preferably, only the negative casting mold is elastically deformed in order to avoid damage to the surface structure applied to the molded part. Since the negative casting mold preferably has a nickel surface according to the invention and the cured impression composition adheres better to the surface of the substrate than to the nickel surface, the provision of release agents is not necessary. Thus, preferably, no release agent is employed in the process according to the invention. Further, in this preferred embodiment of the process, it is not required to clean the negative casting mold because no residues of cured impression composition remain on the negative casting mold. Thus, the negative casting mold has a self-cleaning function.

Advantageously, the process is performed at room temperature. This results in a substantial simplification of process management as compared to conventional processes.

The amount of impression composition introduced into the negative casting mold in step b) is advantageously within a range of from 60 to 100 μl. It is particularly preferred if the impression composition is introduced in exactly that amount that causes a meniscus of impression composition to form throughout the border region of the substrate. This has the advantage that not more than the necessary amount of impression composition is employed, and on the other hand, the layer of the impression composition between the substrate and the negative casting mold is a closed layer.

The process according to the invention is preferably performed in an environment protected from dust in order that an unobjectionable optical quality of the molded parts with the coating according to the invention can be achieved.

Further, it is advantageous if the impression composition is distributed on the negative casting mold only by applying the substrate. The formation of air bubbles and thus a defective formation of the cured layer can be avoided thereby.

The term “luminescent pigments” within the meaning of the present invention includes a group of pigments that re-emit more light in the visible region than is incident. This effect is also referred to as luminescence. This is what distinguishes luminescent pigments from all other pigment types. Luminescent pigments are usually distinguished from luminescent dyes by the fact of being insoluble in the application medium. According to the present invention, the term “luminescent pigments” also synonymously represents the soluble luminescent dyes. Due to the desired extremely low layer thickness, it is required that the pigments, which are insoluble in the medium, have a correspondingly low grain size, which should be smaller than the resulting layer thickness.

A distinction is made between fluorescent pigments, also referred to as daylight luminous pigments, and phosphorescent pigments, also referred to as afterglow pigments. The phenomenon is generally referred to as “fluorescence” if the afterglow has a shorter duration than one thousandth of a second, and if the afterglow duration is longer, the term “phosphorescence” is used.

Inorganic afterglow pigments usually consist of an inorganic basic structure doped with an activator, and mostly co-activators. Two types are essentially employed: the somewhat older pigments based on sulfides, mostly zinc sulfide, or also calcium sulfide, and the more modern luminescent pigments based on alkaline earth aluminates, for example, strontium aluminate. The doping is frequently effected with europium. Green luminescent ZnS pigments are usually doped with copper.

Both pigment types first take up energy by being irradiated. With daylight luminous pigments, ultraviolet light is absorbed and immediately re-emitted in the visible region, while afterglow pigments absorb visible light and re-emit it with a delay. In this context, mention may also be made of the so-called up converters and down converters, known from quantum optics. “Up conversion” means a process in which light is emitted with a photon energy that is higher than that of the exciting light.

Generally, the irradiation raises electrons in the excitation sites, where the activators (e.g., foreign atoms) are, to a higher energy level (“charging”). Upon prolonged irradiation, a saturation state is reached, after which no more energy can be taken up. When the electron falls down to the ground state, the energy is released again in the form of visible light.

Afterglow pigments or phosphorescent pigments show afterglow after being irradiated by visible light. This property is utilized for producing paints and varnishes that afterglow in the dark, having to be charged beforehand by irradiation with light. Such coating substances are referred to as afterglow paints. Phosphorescent pigments based on alkaline earth aluminates have a substantially higher luminous intensity as compared to zinc sulfide pigments and exhibit a substantially longer during luminescence; also, they have the advantage of not turning gray under exposure to ultraviolet light, as is the case with the former. Then again, they take a longer time to be saturated.

As with colored pigments, various colors can also be mixed from luminescent pigments. However, when evaluating the desired color hue, it must be noted that afterglow pigments have two color loci that are usually not identical. One color locus is visible under normal illumination, while the other is visible in the dark.

Fluorescent pigments are employed rather rarely, since fluorescent dyes are preferably employed for applications in neon colors if a higher fastness level is not demanded.

The molded parts and impression compositions according to the invention can be employed, for example, in daylight luminescent paints, in luminous (printing) inks, in instrument displays, TV picture tubes, X-ray and radar screens, luminescent badges, security or signal paints for protective garments, optical brighteners, especially as a security feature, for example, on flexible or rigid carriers, especially banknotes. In addition, the embodiments according to the invention may also be employed in the protection of trademarks and products if those are provided with them. As compared with a comparable protection by the application of holograms, there are improvements here, which manifest themselves, for example, by the well-aimed emission of light of a defined wavelength in the visible and ultraviolet regions as well as in the infrared region. In addition, illumination devices as described, for example, in WO 2006/027304 (A1) can be improved by means of the present invention. This document is included herein by reference in its entirety, and thus, the disclosure of this publication becomes part of the description of the present invention.

Another preferred embodiment of the present invention is characterized in that said luminescent pigments are selected from afterglowing or luminous phosphors.

Even though the amount of luminescent pigments in the embodiments according to the invention is not exceedingly critical since a skilled person can adjust the required concentration to match the intended application, a preferred embodiment of the present invention is characterized in that the luminescent pigments are contained in an amount of from 0.01% by weight to 50% by weight, especially from 1% by weight to 10% by weight, based on the acrylate components.

1. A transparent molded part comprising a sheet-like substrate and, provided on a major surface of said substrate, a layer having a layer thickness within a range of from 3 to 300 μm and consisting of a solvent-free polymerized composition containing:
a) from 35 to 75% by weight of at least one partially fluorinated acrylate;
b) from 24.9 to 60% by weight of at least one non-fluorinated acrylate; and
c) from 0.1 to 5% by weight of at least one photoinitiator;
wherein said layer has a surface structure with diffractive surface elements having a maximum structural size of defects of such surface elements of up to 100 nm on the surface facing away from the substrate, characterized in that said composition contains luminescent pigments.

2. The molded part according to claim 1, characterized in that said partially fluorinated acrylate is linear, branched and/or cyclic, and wherein the carbon atoms adjacent to the acrylate functionality are not fluorinated.

3. The molded part according to claim 1, characterized in that said partially fluorinated acrylate is a perfluoroalkylethyl acrylate, wherein said ethyl group is not fluorinated and, in particular, the perfluorinated alkyl radical has from 4 to 10 carbon atoms.

4. The molded part according to claim 1, characterized in that said partially fluorinated acrylate is contained in an amount of from 50 to 65% by weight.

5. The molded part according to claim 1, characterized in that said non-fluorinated acrylate is contained in an amount of from 34.9 to 45% by weight.

6. The molded part according to claim 1, characterized in that said photoinitiators are contained in an amount of from 1 to 2% by weight.

7. The molded part according to claim 1, characterized by having a viscosity within a range of from 2 to 30 mPa·s.

8. The molded part according to claim 1, characterized by having a density within a range of from 1 to 1.5 g/ml.

9. The molded part according to claim 1, characterized by consisting of a single liquid phase.

10. Essentially pressureless process for the preparation of a molded part according to claim 1, comprising the following steps:
a) providing a negative casting mold with shapings of surface elements;
b) introducing the impression composition according to claim 1 into said negative casting mold in an amount exceeding the shapings of said surface elements;
c) applying a substrate to the exposed surface of said impression composition;
d) polymerizing said impression composition to bond the layer of said impression composition with the substrate for preparing a molded part; and
e) removing the finished molded part from said negative casting mold.

11. Impression composition containing:
a) from 35 to 75% by weight of at least one partially fluorinated acrylate;
b) from 24.9 to 60% by weight of at least one non-fluorinated acrylate; and
c) from 0.1 to 5% by weight of at least one photoinitiator;
characterized in that said composition contains luminescent pigments.

12. Embodiment according to claim 11, characterized in that said luminescent pigments are selected from afterglowing or luminous phosphors.

13. Embodiment according to claim 12, characterized in that said luminescent pigments are contained in an amount of from 0.01% by weight to 50% by weight, based on the acrylate components.
